(19) United States
(12) Patent Application Publication
(10) Pub. No.: US 2006/0256802 A1
(43) Pub. Date: Nov. 16, 2006

(54) Communication system using endpoint devices as routers

(76) Inventor: Paul Edwards, Woodside, CA (US)

Correspondence Address: Michael J. Mallie;BLAKELY, SOKOLOFF, TAYLOR & ZAFMAN LLP, Seventh Floor, 12400 Wilshire Boulevard, Los Angeles, CA, 90025, US

(21) Appl. No.: 11/490,672

(22) Filed: Jul. 20, 2006

Related U.S. Application Data
(63) Continuation of application No. 11/395,642, filed on Mar. 31, 2006.
(60) Provisional application No. 60/667,436, filed on Mar. 31, 2005.

(51) Int. Cl. H04L 12/56

(52) U.S. Cl. 370/401; 370/407

(57) ABSTRACT

A method and system is disclosed herein for a communications system. In one embodiment, the system comprises a hub, a plurality of endpoint devices, and at least one routing endpoint device, from among the plurality of endpoint devices. In one embodiment of the system, the plurality of endpoint devices communicate through the hub in the system. Furthermore, in one embodiment of the system, the at least one routing endpoint device is to route, at least part of the time, endpoint device communication within the communications system.

### PRIORITY

The present patent application claims priority to and incorporates by reference the corresponding provisional patent application Ser. No. 60/667,436, entitled, “Wireless Communication System Using Mobile Devices or Repeaters,” filed on Mar. 31, 2005 and the related nonprovisional parent patent application No. 11/395,642 filed Mar. 31, 2006 titled “Wireless Communication System Using Mobile Devices or Repeaters,” and both applications are incorporated by reference herein.

### FIELD OF THE INVENTION

This invention relates to wireless communication; more particularly, this invention is related to using endpoint devices as repeaters to form a more complete wireless network.

### BACKGROUND OF THE INVENTION

A common form for wireless networks is the Local Cellular Radio Network where there is a fixed base station at the center of a radio cell. The radio cell provides signal coverage for endpoints (e.g., cell phones, wireless devices, etc.) within the radio cell. A cellular network topology is a star topology. The term star network indicates that the network has a hub, or central controlling unit, that directly communicates with endpoints so that all network traffic goes through the hub. Because all traffic goes through the hub, network maintenance and message routing are simple as well as controllable, but such a system lacks flexibility.

Another common form for a network is a mesh network topology. In a mesh topology, each endpoint can communicate directly with other endpoints, and through those endpoints to more remote endpoints that they are connected to. Because communications in a mesh topology do not go through a central coordinating unit, such as a hub, a mesh topology is more flexible and can recover from some network failures by simply re-routing traffic around the failure. However, a mesh topology network requires a large amount of communications routing overhead, which harms network bandwidth.

### GLOSSARY

The following definitions are offered for purposes of illustration, not limitation, in order to assist with understanding the discussion that follows.
802.11—An Institute of Electrical and Electronics Engineer (IEEE) Standard for information exchange between systems. Part 11 includes Wireless LAN Medium Access Control (MAC) and Physical Layer (PHY) specifications for RF networks. See ANSI/IEEE Std. 802.11, 1999 Edition (Reaffirmed 2003).
AP—AP is an abbreviation for Access Point, which is a device that connects wireless communication devices together to create a wireless network. An AP is also a Hub for a star topology, and can be referred to as a Hub or Base Station.
Base Station—A Base Station, is a Hub for a star topology. In this document it is also refered to as an AP or a Hub.
BSS—Basic Service Set—an 802.11 infrastructure node. This node has a star topology with the AP at the Hub.
Cell—Cell is shorthand for Cellular Area, which can be an area covered by a Hub or Base Station or an AP.
Endpoint—A node on a network, in this document also referred to as a terminal or an STA (station in 802.11).
FEC—FEC stands for Forward Error Correction, which is a method utilized to enhance the dependability of data communications by sending redundant information with data so that a receiver can reconstruct the data if there is an error with the data communication.
Flooding—In this context this refers to network flooding. Flooding is when a message is sent out to most or all the nodes in the greater network—the network is flooded with the message. Flooding is frequently used to determine Routing Tables or Network Maps.
Inbound—Inbound refers to network communications traffic which travels from an Endpoint to a Hub.
IP—IP is an acronym for Internet Protocol, which is a packet-based communications protocol for delivering data across communications networks.
LAN—LAN stands for Local Area Network, which is a local network covering a small area such as a one Cell, a college, office, etc.
MAC—MAC is an acronym for Media Access Control, which is a part of Layer-2 of the Open Systems Interconnect's 7-layer model.
Mesh Network—A network topology where endpoints communicate directly with each other, sometimes through other endpoints.
Mesh-Star Topology—A blending of mesh and star topologies, discussed further in this document. Also referred to as enhanced star and extended star topologies and networks.
OSI—OSI stands for Open Systems Interconnection Reference Model, which is a communications system protocol consisting of seven well defined layers.
Outbound—Outbound refers to network communications traffic which travels from a Hub to an Endpoint.
PHY—PHY is an acronym for Physical layer, which is part of Layer-1 of the Open Systems Interconnection's 7-layer model.
PSR—PSR is an abbreviation for Packet Success Rate.
RF—RF is an abbreviation for Radio Frequency.
Router—A router is a network node that receives network traffic from other node(s) and sends that traffic onto yet other node(s). It is called a router because it knows the route to these other nodes.
RSSI—RSSI is an acronym for Received Signal Strength Indication, which is a signal indicating a measurement of the strength (not necessarily the quality) of a received signal in a wireless environment.
Star Network—A network topology where all endpoints communicate through a Hub.
STA—STA is an abbreviation for Station(s), which are communications devices for communicating over a network. STA may refer to endpoint devices or terminal devices in this document, as well as in the IEEE 802.11 Specification.
Unit Addressed—Refers to being addressed to a specific endpoint, not broadcast or multicast.
VoIP—VoIP refers to Voice over Internet Protocol, which is a technology for communicating voice conversations over the Internet or any other IP network.
WAN—WAN stands for Wide Area Network, which is a network that spans a large geographical area.

### SUMMARY OF THE INVENTION

An enhanced communications system is described. In one embodiment, a communication system includes a hub and a plurality of endpoint devices which communicate through the hub. In one embodiment, the communication system further includes at least one routing endpoint device, from among the plurality of endpoint devices, where the routing endpoint device operates to route endpoint device communication of another endpoint device within the communications system, at least part of the time.

Other features and advantages of the present invention will be apparent from the accompanying drawings and from the detailed description that follows below.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a mesh network topology.

FIG. 2 illustrates one embodiment of a star network topology.

FIG. 3 illustrates one embodiment of an enhanced star network topology.

FIG. 4 is a flow diagram of one embodiment of a process for an endpoint device entering an enhanced star network.

FIG. 5 is a flow diagram of one embodiment of a process for an endpoint device handling messages.

FIG. 6A is a flow diagram of one embodiment of a process for a hub receiving messages from endpoint devices.

FIG. 6B is a flow diagram of one embodiment of a process for a hub sending messages to endpoint devices.

### DETAILED DESCRIPTION OF THE PRESENT INVENTION

A method and apparatus is disclosed herein for a communication system using endpoint devices as routers and a method for using the same. In one embodiment, a communications system comprises a hub. A plurality of endpoint devices, such as cell phones, computers, utility meters, etc., communicate with the hub to form a communications network. In one embodiment, among the plurality of endpoint devices, at least one routing endpoint device is included which operates, at least part of the time, as a router within the communication system. As a result of the routing endpoint device, the communication system has a topology that like a star topology where all message traffic goes through the hub, but also has a topology like a mesh topology that can use any available network router-endpoint to route message traffic to and from the hub.

In one embodiment, by including at least one endpoint device, which may be configured to act as a router, a radio cell or other communications network may be extend to create an enhanced star network. One might think of such an enhanced star network as a mesh-star network. Beneficially, in one embodiment an endpoint device need not actually be in range of a hub, but simply be in range of another endpoint device that is itself within range of the hub. Such a communication network may be expanded recursively where each endpoint device is in range of another endpoint device that is, in turn, in range of another endpoint device that is communicating with the hub. This recursion can practically go on for many “hops.”

The enhanced star network, as illustrated by the Figures and described below, includes the robust feature of a mesh network, where an endpoint device can communicate with and through many of its neighbors. Furthermore, like a star network, an endpoint device will direct all of its message traffic to a central communications controller, such as a base station, hub, etc.

In one embodiment, an enhanced star network can be used in a “fixed point” cellular radio application. “Fixed point” cellular radio applications include, but are not limited to, meter reading networks for electric, gas, or water utility companies. In another embodiment, an enhanced star network could be utilized to extend a wired communications network in areas where there are physical limitations to endpoint device spacing. In one embodiment, a network of this type can extend the reception area for a base station within a mobile cellular radio network. The routing methods, as described in greater detail below, however, should not be limited to the networks just described as any communications network could be expanded by the routing methods. The routing methods described below can become more dynamic for mobile applications by running the routing algorithms more frequently.

The exemplary embodiments, as will be discussed herein, utilize the ANSI/IEEE Std. 802.11, 1999 Edition (Reaffirmed 2003) communications protocol (hereinafter referred to as “802.11” or “802.11 protocol”), which is a communications protocol for the Physical (PHY) and Medium Access Control (MAC) data communications layers. The systems and methods described below, however, could use other communications systems, such Bluetooth, cellular phone networks, etc. Furthermore, as discussed below by way of example, and not by way of limitation, an 802.11 implementation is discussed to impart understanding of the more general principals of the present application. There exist numerous communications systems and communications devices that may benefit from an enhanced star network and an enhanced star network topology.

In one embodiment, some functions of a communications network that have been traditionally performed in a communications layer above the data link layer (OSI 7 layer model) are moved into the data link layer. The 802.11 protocol already shifts non-traditional functions into the Data Link Layer, including fragmentation and security. Routing, balancing, and other topology functions for an enhanced star network can also be moved down into layer-two, or another low layer, and be transparent to the higher layers.

One technology in which an enhanced star network is particularly attractive is the 802.11 standard for high speed RF data communication. The methods described below may be seamlessly deployed alongside standard 802.11 in the same Local Area Network (LAN) without effecting non-participating endpoint device. That is, a standard endpoint device is configured to only respond to messages addressed to itself. Any message not addressed to that endpoint device is ignored by the endpoint device. Thus, the additional messages communicated in an enhanced star network, are simply ignored by a non-participating endpoint devices.

In many wireless systems, a single frequency is used for all communication. When more than one endpoint communicates on the frequency at a time, there will be collisions. As all endpoints may not be able to directly reach (hear) each other in this system, two endpoints may be able to transmit at the same time with no collision—if they, and their respective receivers, are too far apart to hear each other. This near-far effect can be taken advantage of to increase network flexibility in an enhanced star network, according to the embodiments discussed herein. Transmit power can be adjusted to take advantage of near-far characteristics and reduce interference with other endpoint-repeaters—i.e. transmit only powerfully enough to be heard by the target endpoint-repeater, and not interfere with other links.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Enhanced Star Network Topology

In one embodiment, an enhanced star network and a method of implementing the same are described. The enhanced star network includes features and benefits of existing networks and network topologies. Furthermore, an enhanced star network need not impact existing endpoint devices within the network which do not support/implement the methods described below.

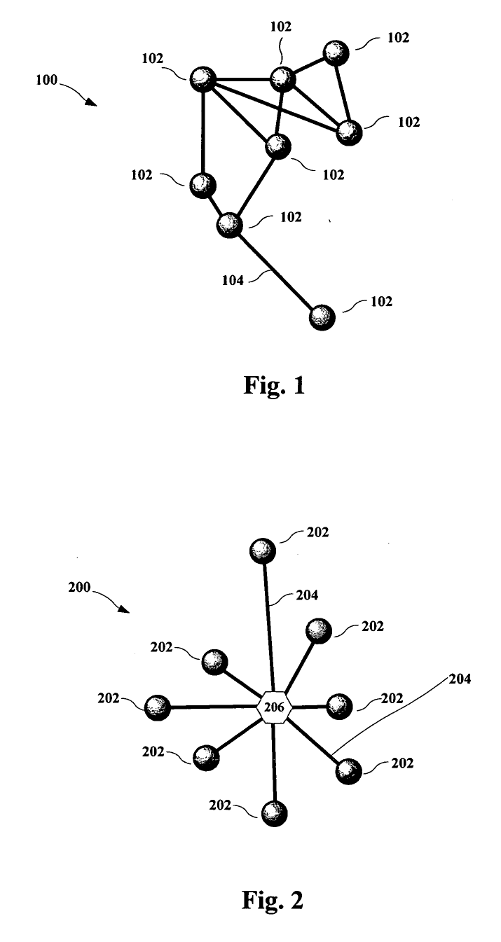

FIG. 1 illustrates one embodiment of a mesh network embodying a mesh network topology. Mesh network 100 includes a plurality of endpoint devices 102, such as cell phones, personal computers, electronic meter reading devices, etc. Each endpoint device 102 is in communication with some other endpoint device(s) 102 within the network 100. If one endpoint device fails or goes out of the network, communications between the remaining endpoint devices can still take place if the links between endpoint devices are available.

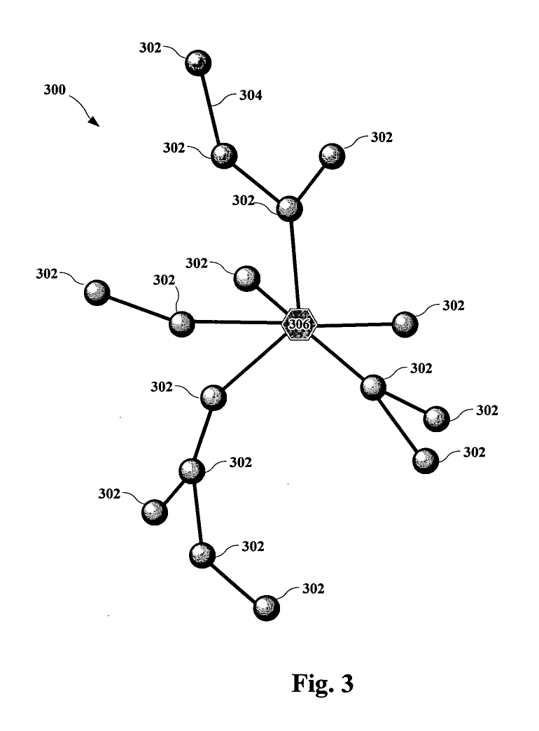

FIG. 2 illustrates one embodiment of a star network embodying a star network topology. Star network 200 is comprised of a hub 206. Communications protocols that may be used in a star network include 802.11, Global System for Mobile Communications (GSM), etc. Each endpoint device 202 within the star network communicates 204 directly with hub 206. Each endpoint device 202 only includes the fimctionality to communicate directly with the hub 206 using communications methods well known in the art. A hub, such as hub 206, however may be limited to a physical range in which endpoint devices 206 can send and/or receive communications from hub 206. Consequently when an endpoint device is outside of the range of hub 206, whether it be cellular range, physical range, technical limitations, etc., the endpoint device fails to be connected to the communications network.

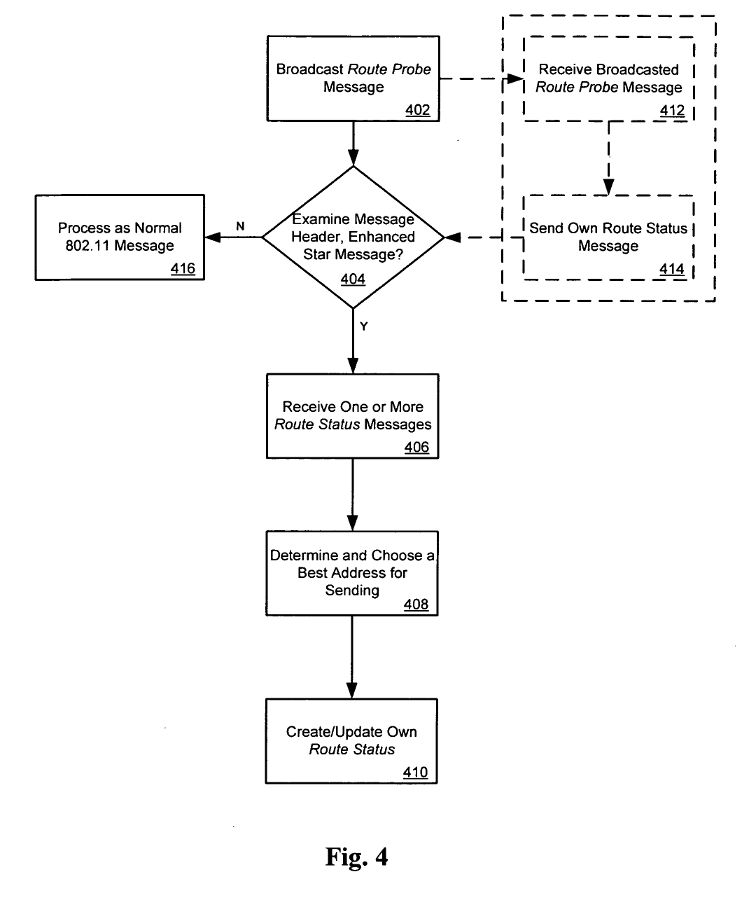

FIG. 3 illustrates one embodiment of an enhanced star network topology. In one embodiment, enhanced star network 300 combines the two network philosophies discussed above with respect to star network 200 and mesh network 100 to extend the range of a traditional star topology by allowing an endpoint device, such as endpoint device 302 to communicate with Hub through other endpoint devices.

With an enhanced star network topology, a network can grow to cover large areas as in a mesh topology. With this enhanced star topology, balancing and routing is a relatively simple matter as in a Star topology. With the mesh-star topology mapping and statistics for the system are kept in a central location, such as a hub. Beneficially, the system is dynamic and expandable while being controlled and maintainable.

In one embodiment, all network traffic will go to (inbound) and from (outbound) hub 306, but not necessarily be directly addressed to or from hub 306. If the transmission environment puts the base station out of range of an endpoint device, the endpoint device can instead send its traffic to a closer endpoint device that can in turn send that traffic (perhaps recursively through more endpoint devices) to hub 306.

As discussed below, an enhanced star network is made possible when, in one embodiment, at least one endpoint device in the extended star network acts, at least part of the time, as a router to extend the network.

Sub-Net Routing in an Enhanced Star Network

Conventionally, routing is reserved for the greater network, and not for the relatively simple local networks. Endpoint devices within local networks traditionally have no need for routing, as they simply send all network traffic to the network router. In an enhanced star network, however, each endpoint device has some rudimentary knowledge of routing, as will be discussed in greater detail below. More particularly, each endpoint device which has entered an enhanced star network, and which is a participating endpoint device, knows a “best address” to send a packet to reach a hub. Each endpoint device that receives inbound traffic is able to then forward that traffic along to the best address toward the hub. An endpoint device also is able to process an address header, for a received packet, that indicates an address where outbound traffic should be directed. Processes which allow an endpoint device to process data packets, or messages, to create an enhanced star network are discussed below.

In one embodiment, this form of simple routing can be done at layer-two (the Data Link Layer) of the 7-layer OSI model, using MAC or physical address rather than the more traditional IP addresses. In another embodiment, the routing may be done at a higher layer, and use the IP address if desired.

Network Balancing and Best Route Calculation for an Endpoint Device

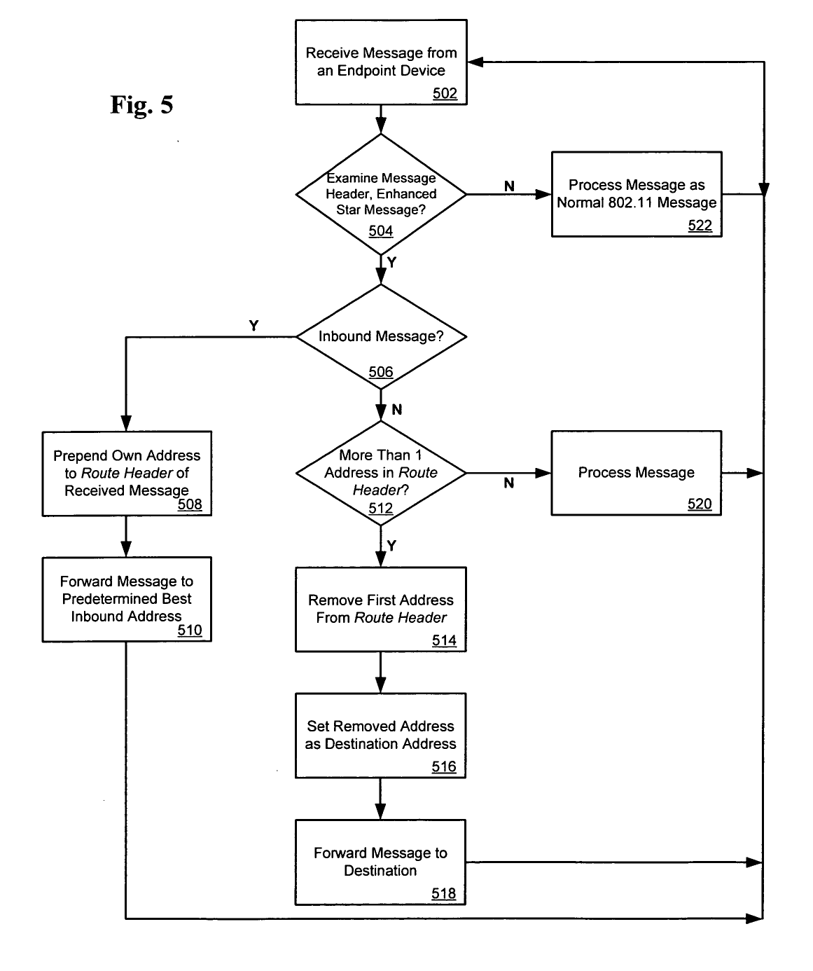

FIG. 4 is a flow diagram of one embodiment of a process for an endpoint device entering an enhanced star network. The process is performed by a processing logic that may comprise hardware (circuitry, dedicated logic, etc.), software (such as is run on a general purpose computer system or a dedicated machine), or a combination of both. In one embodiment, processing logic exists within each endpoint device to support an enhanced start network according to the discussion above. Network balancing and best route calculation are done by the terminal stations in a distributed manner.

In one embodiment, the process begins when processing logic of an endpoint device broadcasts a Route Probe message upon entering an enhanced star network (processing block 402).

In one embodiment, a processing logic within each of a plurality of endpoint devices, which are already communicating in an enhanced star network, receive the broadcasted route probe message (processing block 412). In one embodiment, upon receiving the message, processing logic examines the message header to determine if the message is an extended star network message. Such information indicating that the message is an extended star message may be contained in a header of the message. Processing logic aboard these endpoint devices then respond with a Route Status message for that endpoint device (processing block 414), the Route Status message discussed in more detail below. Note that processing blocks 412 and 414 are illustrated in dashed lines to distinguish the process for a new endpoint device entering an enhanced star network and those processes performed by endpoint devices already communicating within an enhanced star network.

Processing logic examines the message headers of the received messages to determine if the messages are enhanced star network messages (processing block 404). If the received message is not an enhanced star message, the processing logic processes the received message as a normal 802.11 message (processing block 416). However, if processing logic does determine that the message is an enhanced star message, processing logic of the endpoint device then receives the one or more enhanced star Route Status messages (processing block 406) from those endpoint devices that responded to the Route Probe message. In one embodiment, the Route Status message may contain one or more of the following pieces of information:

| | | | |
|---|---|---|---|
| UINT32 | JumpsToBaseStation | /* | number of hops to get to |
| | | | base station */ |
| UINT32 | RouteEndpointsSupported | /* | number of endpoint devices |
| | | | using this route */ |
| UINT32 | TotalEndpointsSupported | /* | endpoint devices on this |
| | | | frequency on this base |
| | | | station*/ |
| UINT32 | InboundWeakRSSI | /* | RSSI of weakest In hop to |
| | | | base station */ |
| UINT32 | OutboundWeakRSSI | /* | RSSI of weakest Out hop to |
| | | | base station */ |
| UINT32 | ProbeRSSI | /* | RSSI of the received Route |
| | | | Probe */ |

The endpoint device entering the network collects the received Route Status messages and the information contained within the messages, and processing logic of the endpoint device determines the best network to join and a best address for sending packets in order to get to the network's hub (processing block 408). In one embodiment, the endpoint device determines the best address (i.e., a communications route) based on a heuristic that reduces and/or minimizes the JumpsToBaseStation and RouteEndpointssupported while increasing (e.g., maximizing) the different RSSI readings.

In one embodiment, a hub could also receive a broadcasted Route Probe message (processing block 412), and therefore would respond with a Route Status message (processing block 414) after examining the message header (processing block 406) for the broadcasted message. The hub's Route Statue message, however, would have a JumpsToBasestation value of zero. The ProbeRSSI and InboundWeakRSSi are equal for a Route Status response message from a hub. In one embodiment, a hub has an OutboundWeakRSSi equal to 0 as the RSSI of the only outbound hop is measured by the endpoint device receiving the Route Status message.

In one embodiment each endpoint sends the Route Probe message to its immediate neighbors, and these queries do not propagate beyond the neighbors. Thus, there is no network flooding to establish a route. In this embodiment, each endpoint only establishes a single hop on the best route, and does not need to establish or know the entire route. The entire route is established by the network as a whole, and stored (as we will later see) in the network hub. Thus establishing routes is done in a distributed manner, and no single network entity is burdened with this task. As seen in this embodiment, the network traffic required to establish and maintain these routes is distributed and proportionally fixed—thus as the network grows, the overhead for routing does not. In this embodiment, these routes can be updated at any time by repeating the above process—this is beneficial in a mobile application.

After choosing the best route (address) to the base station, processing logic of a endpoint device creates/updates its own Route Status message (Processing Block 410) for later use in response to any Route Probe message it may receive (e.g., processing blocks 412 and 414). This new Route Status message will be based on the Route Status response of the inbound route chosen by the endpoint device. In one embodiment, a endpoint device's Route Status message increments the JumpsToBaseStation of the chosen route by one. The endpoint device's Route Status message also increments TotalEndpointsSupported value by one (more than one if the endpoint device is recursively supporting other endpoint devices). The endpoint device's Route Status message decreases the OutboundWeakRSSI if the RSSI of the chosen Route Status response is lower. The endpoint device's Route Status message decreases the InboundWeakRSSI if the ProbeRSSI in the chosen Route Status message is lower. In one embodiment, aspects of each endpoint device's Route Status message are periodically updated by the base station in a Route Update messages unit-addressed to the endpoint device.

There are values besides RSSI that can be used to determine the best or most favored transmit address. These include, for example, PSR and FEC performed, among others.

In one embodiment, an endpoint device that knows/remembers a first address on the inbound route is able to communicate over an enhanced star network.

Endpoint Device Message Handling

In one embodiment, all inbound and outbound message traffic in an enhanced star network that goes over more than one hop (e.g., is not directly addressed to/from the base station) has a Route Header. The Route Header is an additional data element that is inserted after an existing packet header for a network message. In one embodiment, the packet header will have an indication that signals there is a Route Header present in the current message. In another embodiment, a pattern in the body of a message itself will indicate that a Route Header is present. Such an indication could include special address(es) or specific pattern(s) in packet header field(s). The indication could also be, in 802.11, a reserved management type or perhaps simply a specific from address.

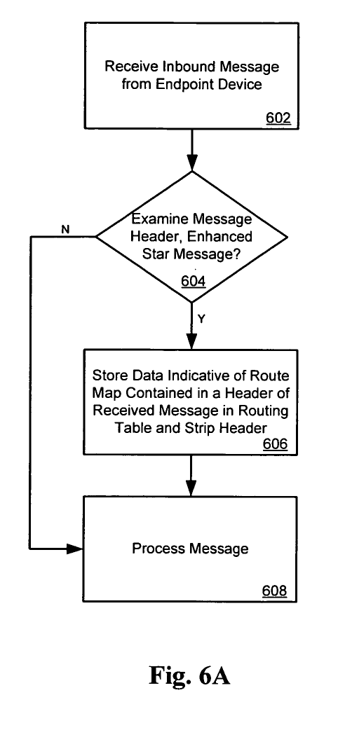

FIG. 5 is a flow diagram of one embodiment of a process for a endpoint device handling messages. The process is performed by a processing logic that may comprise hardware (circuitry, dedicated logic, etc.), software (such as is run on a general purpose computer system or a dedicated machine), or a combination of both. In one embodiment, processing logic exists within each endpoint device supporting an enhanced start network.

Processing logic of an endpoint device receives a message from another endpoint device (processing block 502). As noted above, message traffic going in toward the base station has an indication in the Route Header signaling that the message traffic inbound, while traffic going away from the base station has an indication that the message traffic is outbound. Processing logic examines the Route Header for the received message (processing block 504) in order to determine whether the message is an enhanced star network message. If the message is not an enhanced star message, processing logic processes the message as a normal 802.11 message (processing block 522). But if the message is determined to be an enhanced star message, processing logic further determines whether the message is inbound or outbound (processing block 506). If the message is inbound, processing logic pre-pends its own address onto the Route Header of the received message (processing block 508) and forwards the message along that endpoint device's predetermined “best route” (processing block 510). Processing logic of the endpoint device then returns to processing block 502 to await receiving and/or sending another message. As noted above, when the inbound message reaches the hub, the entire route for the originating endpoint device will be contained in the Route Header, and the hub can update its routing tables accordingly.

In one embodiment after the route has been established in the hub, a streamlined, non-pre-pending, inbound header can be employed. Using this type of streamlined header, processing logic for the intervening endpoint devices would not pre-pend their addresses to the inbound header, and the hub would not be able to update its route tables using the inbound header. The hub would need to rely on the last fully address-pre-pended packet for the out-bound route header. In radio networks the overhead of this address-pre-pended header is small when compared to the preamble and packet time, and thus may be of limited value.

If processing logic determines that a message is not inbound (processing block 506), by reading the indication in the Route Header signaling that it is Outbound, the endpoint device examines the Route Header to determine if the Route Header contains zero, one or more addresses (processing block 512). If there is more than one address in the Route Header, processing logic of a endpoint device removes the first address from the Route Header (processing block 514) and sets the removed address as the destination address for the packet (processing block 516) before forwarding the message along its route (processing block 518). If, at processing block 512), processing logic determines there is no Route Header, the Route Header does not contain any address, or in one embodiment where one address for the hub is in the Route Header, processing logic assumes that the packet is for the endpoint device, and processes the message accordingly (processing block 520). In either case, processing logic returns to processing block 502.

Broadcast and multicast messages can be focused and localized to selected portions of the network by the Hub—this can be achieved by simply having the final address in an outbound route header be the broadcast or multicast address. Broadcast Messages could also be handled by simply having all endpoint devices that know they are acting as routers, re-broadcast the message, perhaps with an indication that it is a repeat, like using the same sequence number. This way it will be dropped by entities that also received the first message. Short backoffs can also be employed to avoid contention.

Routing Tables

Up-to-the-moment routing information will be kept at a central location—for example the Hub or base station. The hub maintains a routing table based on the latest traffic inbound from each endpoint. Inbound traffic can contain the addresses of all endpoint devices on the inbound route, and the base station pre-pends this route map to all outbound traffic (in the Route Header). If a route changes, all an endpoint device needs to do to register this change is send an inbound message to the Hub, where the route tables can be updated. This simple mechanism is particularly important in a network where the endpoints are mobile, and the routes may change frequently. The Hub uses its complete routing tables to also update routes to endpoints that rely on the changed endpoint.

In one embodiment the Hub can periodically update each endpoint device it is responsible for with information on the overall network, and on the portion of the network pertinent to the endpoint. In one embodiment, this information comes in the form of a unit addressed Route Update message from the hub.

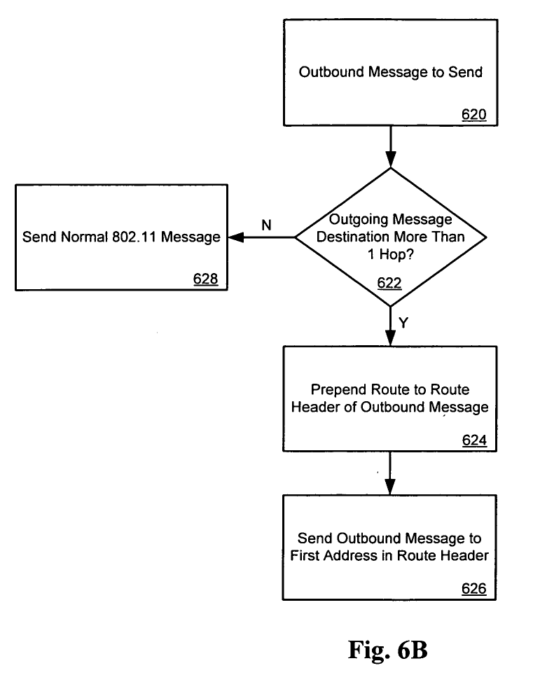

FIG. 6A and 6B are flow diagrams of one embodiment of a process for a base station handling messages to and from endpoint devices. The process is performed by a processing logic that may comprise hardware (circuitry, dedicated logic, etc.), software (such as is run on a general purpose computer system or a dedicated machine), or a combination of both. In one embodiment, processing logic exists within a base station supporting an enhanced start network.

In one embodiment, the process begins when processing logic of the base station receives an inbound message from a endpoint device (processing block 602). Processing logic then examines the message header to determine if the message is an enhanced star network message (processing block 604). If processing logic determines that the message is not an enhanced star message, then the process continues to processing block 608 where the message is processed. However, if processing logic determines that the message is an enhanced star message, processing logic stores data indicative of the Route Map which is contained in an inbound Route Header of the received message in a routing table and then strips the message header from the received message (processing block 606), thereby updating a routing table being maintained by processing logic. As noted above, the routing table provides up-to-the-moment routing information for the endpoint devices within an enhanced star network. Processing logic within the base station then processes the received message (processing block 608).

When a message is to be sent outbound by processing logic (processing block 620), processing logic first determines whether the outbound message has a destination that is more than one hop away from the hub (processing block 622). That is, processing logic determines whether the message will be routed by at least one routing endpoint device. If the message is determined to be destined for an endpoint device that is one hop from the hub, processing logic sends a normal 802.11 outbound message (processing block 628). But if processing logic determines that an outgoing message will go over one or more hops before reaching its destination, processing logic pre-pends a received Route Map to a Route Header of an outbound enhanced star network message (processing block 624). After processing logic has created the message header for the outbound enhanced star message, processing logic sends the outbound message to the first address contained in the Route Header (processing block 626).

In one embodiment, the hubs/base stations can, if need be, communicate with each other (over a WAN backbone) to keep track of the endpoint devices supported by each hub/base station. Even a fixed endpoint device, such as a computer, wireless meter, etc., may move from one hub/base station to another depending on the transmission environment or the loads in each cell.

### 802.11 EXAMPLE

As previously stated, the 802.11 communications protocol may be used to implement an enhanced start network. The example discussed below uses 802.11 as a foundation for the implementation. As mentioned above, 802.11 is not required to implement the techniques described herein, but, it is offered as a well understood layer-one-and-two data protocol, as it will be referred to here. In this example the processes described by this method would be performed above the PHY layer and below the MAC layer, and be transparent to the layers above and below. Because this is an example of how techniques described herein could be implemented over 802.11, it is not intended to be an exclusive avenue for implementation.

Send Route Probe

When a new endpoint device comes into a network area. The new endpoint device broadcasts a Route Probe message, as discussed above. The message header indicates that it is a routed message, and the Route Header indicates that it is a Route Probe. The endpoint devices and/or base stations receive the broadcast to examine and respond to the Route Probe.

| Preamble | 802.11 Header | Route Header | DATA . . . |
|---|---|---|---|
| | ToDS and FromDS | Type Field = Probe | |
| | both set | 1^{st} Address = True | |
| | Source Address = | Source Address | |
| | 1.2.3.4.5.6 | | |

One skilled in the art will recognize the above illustrated structure as a format for 802.11 messages where the preamble is used to provide synchronization features during messaging, the 802.11 Header is a standard 802.11 header, and the DATA section (as well as other segments following the DATA segment left out of the illustration). However, the message includes a Route Header data field has been added as described in greater detail above. For the remainder of this example, the DATA field will be omitted.
Respond with Route Status

In one embodiment, all endpoint devices receiving the Route Probe broadcast responds with a unit-addressed Route Status message. In one embodiment, the Route Status message was pre-created by the endpoint device (unless a received RSSI forces a lowering of the InboundWeakRSSI), and reflects the current routing status for the endpoint device.

| | | |
|---|---|---|
| Preamble | 802.11 Header | Route Header |
| | ToDS and FromDS both set | Type Field = Status |
| | Source Address = 1.2.3.4.5.6 | 1^{st} Address = True |
| | | Source Address |

Create and Update Route Status

With the information, a endpoint device can gather:

Inbound Routed Traffic:

| | | |
|---|---|---|
| Preamble | 802.11 Header | Route Header |
| | ToDS and FromDS both set | Type Field = Inbound |
| | Source Address = 1.2.3.4.5.6 | Pre-pend station's address |

Outbound Routed Traffic:

| | | |
|---|---|---|
| Preamble | 802.11 Header | Route Header |
| | ToDS and FromDS both set | Type Field = Outbound |
| | Source Address = 1.2.3.4.5.6 | Peel and use first address |

Update Route

In one embodiment, periodically, endpoint device may re-broadcast the Route Probe message, and re-evaluate the best route to a base station. For example, a endpoint device may re-evaluate a communication route if the PSR to the base station drops. As noted above, the 802.11 example was provided to impart understanding to the processes and systems described above, and was not provided by way of limitation.

Beacon messages in an 802.11 BSS can be distributed in the same way as any other broadcast message. As every beacon need not be successfully received by every endpoint, an algorithm may be employed to have any specific beacon be directed to only a portion of the network to reduce contention.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

I claim:

1. A communications system, comprising:
a hub;
a plurality of endpoint devices that communicate through the hub; and
at least one routing endpoint device, from among the plurality of endpoint devices, wherein the at least one routing endpoint device is to route, at least part of the time, endpoint device communication of another endpoint device within the communications system.

2. The communications system of claim 1, wherein the communications system is a star communications network extended by the at least one routing endpoint device.

3. The communications system of claim 2, wherein the star communications network extended by the at least one routing endpoint device creates an enhanced star network topology.

4. The communications system of claim 1, wherein the hub is operable to maintain a network routing table for the communications system.

5. The communications system of claim 4, wherein the hub is operable to direct a message from the hub to one of the plurality of endpoint devices along a message route, the message route determined from the network routing table.

6. The communications system of claim 1, wherein the at least one routing endpoint device is operable to determine an address with which to route communication of the at least one routing endpoint device, without maintaining a network routing table; and store the address in a memory of the at least one routing endpoint device.

7. The communications system of claim 6, wherein the address indicates a single address with which to route communication.

8. The method of claim 7, wherein the address is an address representing an optimum communication route.

9. The communications system of claim 1, wherein a routing query of the at least one routing endpoint device is a local routing query that does not flood the communications system.

10. The communications system of claim 9, wherein the routing is transparent to data communications levels, of the Open Systems Interconnect communications model, above the Data Link Level.

11. The communications system of claim 1, further comprising:
at least one endpoint device that is not configured to route endpoint device communication within the communications system.

12. The communications system of claim 1, wherein the communication system is an Institute of Electrical and Electronics Engineers (IEEE) 802.11 basic service set communications system.

13. The communications system of claim 1, wherein the at least one routing endpoint is a cellular phone.

14. The communications system of claim 1, wherein the at least one routing endpoint is a Bluetooth device.

15. The communications system of claim 1, wherein the at least one routing endpoint is a personal computer.

16. The communications system of claim 1, wherein the at least one routing endpoint is a utilities meter.

17. A routing endpoint device, for use in a communications system with a hub and a plurality of endpoint devices that communicate through the hub, wherein the routing endpoint device is operable to route, at least a part of the time, endpoint device communication of another endpoint device within the communications system.

18. A method, comprising:
a routing endpoint device routing endpoint device communication within a communications system of another endpoint device within the communications system to a hub in the communications system.
